(19) United States
(12) Patent Application Publication
(10) Pub. No.: US 2021/0246578 A1
(43) Pub. Date: Aug. 12, 2021

(54) ACID-DYEABLE SPANDEX FROM CATIONIC POLYURETHANE

(71) Applicant: The LYCRA Company LLC, Wilmington, DE (US)

(72) Inventors: Alberto CERIA, Buccinasco (MI) (IT); Hong LIU, Waynesboro, VA (US); Steven W. SMITH, Waynesboro, VA (US); Kelly L. STANO, Roanoke, VA (US); Robert O. WALDBAUER, JR., Waynesboro, VA (US)

(73) Assignee: The LYCRA Company LLC, Wilmington, DE (US)

(21) Appl. No.: 17/254,544

(22) PCT Filed: Jul. 3, 2019
(86) PCT No.: PCT/US2019/040445

§ 371 Date: Dec. 21, 2020

Related U.S. Application Data
(60) Provisional application No. 62/694,754, filed on Jul. 6, 2018.

(51) Int. Cl. D01F 6/70; D01F 1/10; D01F 6/94

(52) U.S. Cl. CPC D01F 6/70; D01F 1/10; D10B 2401/14; D10B 2401/061; D10B 2331/10; D01F 6/94

(57) ABSTRACT

Compositions containing spandex and quaternary amine additives for use in filaments, fiber and articles of manufacture having improved wash fastness when dyed with acid dyes are provided. Methods for production of these compositions are also provided.

### FIELD OF THE INVENTION

This disclosure relates to spandex containing quaternary amine additives incorporated by a polyurethane addition route and to spandex filaments and fiber having improved wash fastness when dyed with acid dyes and articles of manufacture prepared from the spandex, filaments and/or fiber. Methods for production of the spandex are also disclosed.

### BACKGROUND OF THE INVENTION

Acid dyes are readily available and known to have good light fastness and ease in application. However, when these dyestuffs are applied to spandex there can be difficulty arising from unsatisfactory wash fastness of the dyed fiber. Further, the low pH at which the dyeing occurs can be corrosive to the dyeing equipment and degradative to some fiber types.

Accordingly, most competitive spandex products include a tertiary amine additive. However, these additives result in a slower dyeing product with lower chroma yield.

U.S. Pat. No. 3,294,752 discloses textile fibers and shaped articles prepared from segmented elastomers having improved dyeability and wash fastness when dyed with acid dyes. The fibers and shaped articles comprise a long-chain synthetic elastomer composed of at least 85 percent of a segmented polyurethane containing 0.05 percent to 2 percent by weight of quaternary nitrogen in the elastomer chain wherein the segmented polyurethane consists essentially of first and second segments alternating in the polymer chain with the first segments consisting of a polymer melting below 60° C. and having a molecular weight above 600 and the second segments consisting of at least one repeating unit of a polymer having a melting point above 200° C. in a fiber-forming molecular weight range. In this disclosure, the quaternary nitrogen reactive group is incorporated into the segmented polyurethane via direct polymerization.

However, direct polymerization is difficult to implement commercially.

U.S. Pat. No. 6,221,954 discloses preparation and use of quartenized bis hydroxyl alkyl amines for use in preparation of cationic polyurethane compositions disclosed to be useful in formation of stable films, coating compositions and as a coreactant in the production of polyurethane films.

U.S. Pat. No. 6,403,682 discloses a spandex containing about 3-100 meq of quaternary amine functionality/kg of spandex wherein the quaternary amine is an additive selected from the group consisting of (a) oligomers comprising the reaction product of at least one diisocyanate selected from the group consisting of 1-isocyanato-4-[(4-isocyanatophenyl)methyl]benzene, 1-isocyanato-2-[(4-isocyanatophenyl)methyl]benzene, 4-methyl-1,3-phenylene diisocyanate, 5-isocyanato-1-(isocyanatomethyl)-1,3,3-trimethyl-cyclohexane, 1,6-diisocyanatohexane and bis(4-isocyanatocyclohexyl)methane), and at least one quaternary amine selected from the group consisting of N,N-dialkyl-N,N-dialkanolammonium chlorides and N,N-dialkyl-N,N-dialkanolammonium alkylsulfates, wherein the alkanol grouping contains 2-4 carbon atoms. The resulting spandex is disclosed to have improved heat-set efficiency.

There is a need for commercially adaptable acid dyeable spandex with improved wash fastness.

### SUMMARY OF THE INVENTION

The present disclosure relates to an acid dyeable polymer prepared via a commercially adaptable process from cationic polyurethane which exhibits excellent wash fastness.

Accordingly, an aspect of the present invention relates to a composition comprising spandex and a cationic polyurethane containing N,N-dialkyl-N,N-dialkanolammonium alkylsulfonate.

Another aspect of the present invention relates to filaments and fiber having improved dyeability and wash fastness when dyed with acid dyes. The fiber is produced from spandex and a cationic polyurethane containing N,N-dialkyl-N,N-dialkanolammonium alkylsulfonate.

Another aspect of the present invention relates to an article of manufacture, at least a portion of which comprises a composition or fiber comprising spandex and a cationic polyurethane containing N,N-dialkyl-N,N-dialkanolammonium alkylsulfonate.

Yet another aspect of the present invention relates to a method of improving dyeability and wash fastness of spandex when dyed with acid dyes. The method comprises adding a cationic polyurethane containing N,N-dialkyl-N,N-dialkanolammonium alkylsulfonate to spandex by a polyurethane addition route.

### DETAILED DESCRIPTION OF THE INVENTION

This invention relates to commercially producible spandex with improved acid-dye reactivity and wash fastness as well as methods for production of the spandex, filaments and fiber produced from the spandex and articles of manufacture, at least a portion of which comprise this spandex.

The term “spandex” is used herein in its generic sense to mean a manufactured fiber in which the fiber-forming substance is a long chain synthetic polymer comprised of segmented polyurethane and/or polyurethane urea. Spandex compositions are well-known in the art and may include many variations such as those disclosed in Monroe Couper, Handbook of Fiber Science and Technology: Volume III, High Technology Fibers Part A. Marcel Dekker, INC: 1985, pages 51-85.

In this invention, a cationic polyurethane is added to a spandex polymer for improved acid-dye reactivity and easy commercial adoption. In one nonlimiting embodiment, the cationic polyurethane contains N,N-dialkyl-N,N-dialkanolammonium alkylsulfonate. In one nonlimiting embodiment of this invention, a quaternized alkylsulfonate polyurethane polymer is added to spandex. Without be limited to any particular theory, it is believed that addition of the quaternary ammonium moiety in accordance with the present invention increases dye rate kinetics under competitive dye bath with polyamide.

The present invention thus provides composition comprising spandex and a cationic polyurethane containing N,N-dialkyl-N,N-dialkanolammonium alkylsulfonate.

Also provided by the present invention are methods for improving dyeability and wash fastness of spandex when dyed with acid dyes. The methods comprise adding a cationic polyurethane to the spandex. In one nonlimiting embodiment, the cationic polyurethane contains N,N-dialkyl-N,N-dialkanolammonium alkylsulfonate. In one nonlimiting embodiment of this invention, a quaternized alkylsulfonate polyurethane polymer is added to spandex. In one nonlimiting embodiment, the cationic polyurethane is added by a polyurethane addition route.

In one nonlimiting embodiment, dimethylethanolamine is reacted with ethylene oxide a reaction vessel with slight excess of methane sulfonic acid to produce N,N-bis(hydroxyethyl) N,N-dimethyl quaternary ammonium methane sulfonate having the structural formula:

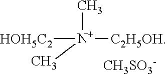

This N,N-bis(hydroxyethyl) N,N-dimethyl quaternary ammonium methane sulfonate is also commercially available under the trade name Variaquat 2MS from Evonik Corp. (Parsippany, N.J.). These quaternized ammonium salts are particularly useful for the preparation of polyurethanes because they have two active hydrogen atoms which can be readily reacted with isocyanate groups to form a polyurethane. Using these quaternary ammonium salts, cationic polyurethane compositions can be prepared directly by reaction with a polyisocyanate and additional polyols.

Also provided by the present invention are filaments and fiber having improved dyeability and wash fastness when dyed with acid dyes produced from spandex and a cationic polyurethane containing N,N-dialkyl-N,N-dialkanolammonium alkylsulfonate. Methods for production of such filaments and fibers are well known in the art and need not be described in detail herein.

In addition, the present invention provides articles of manufacture, at least a portion of which comprises a composition, filament or fiber of the present invention.

In one nonlimiting embodiment, the article of manufacture is fabric.

Fabrics comprising spandex of the present invention may have a spandex content of about 0.5 weight percent (wt. %) to about 40 wt. %, based on weight of the fabric. For example, circular knits comprising spandex may contain from about 2 wt. % to about 25 wt. % spandex, leg wear comprising spandex may contain from about 1 wt. % to about 40 wt. % spandex, raschel fabric comprising spandex may contain from about 10 wt. % to about 40 wt. % spandex, and warp knit tricots comprising spandex may contain from about 14 wt. % to about 22 wt. % spandex.

The spandex or the fabric comprising the spandex of the present invention may be dyed and printed by customary dyeing and printing procedures, such as from an aqueous dye liquor by the exhaust method at temperatures between 60° C. and 100° C., by padding the material comprising the spandex with dye liquors, or by spraying the material comprising the spandex with dye liquor. Conventional methods may be followed when using an acid dye. For example, in an exhaust dyeing method, the fabric can be introduced into an aqueous dye bath having a pH of between 3 and 9 which is then heated steadily from a temperature of approximately 20° C. to a temperature in the range of 40-100° C. over the course of about 10-80 minutes, The dye bath and fabric are then held at temperature in the range of 40-100° C. for from 10-60 minutes before cooling. Unfixed dye is then rinsed from the fabric. Stretch and recovery properties of the spandex are best maintained by minimal exposure time at temperatures above 100° C.

High color yields, color strength, and a degree of levelness can be obtained for the spandex or the fabric comprising the spandex when dyed with non-metalized acid leveling dyes (relative molecular mass 250-950) applied under acidic to slightly alkaline conditions, pre-metalized dyes containing a metal atom, for example chromium or cobalt, applied under acidic to slightly alkaline conditions, and reactive dyes applied under acidic or neutral to slightly alkaline conditions of pH 4-9 in exhaust or pad applications. Generally, the spandex of the invention may be dyed with reactive dyes that are conventionally used to dye polyamide or wool yams containing amine end groups.

All patents, patent applications, test procedures, priority documents, articles, publications, manuals, and other documents cited herein are fully incorporated by reference to the extent such disclosure is not inconsistent with this invention and for all jurisdictions in which such incorporation is permitted.

The following Examples demonstrate the present invention and its capability for use. The invention is capable of other and different embodiments, and its several details are capable of modifications and/or substitution in various apparent respects, without departing from the spirit and scope of the present invention. Accordingly, the Examples are to be regarded as illustrative in nature and non-limiting.

### EXAMPLES

### Example 1

Diphenylmethane diisocyanate (60.2 grams isonate), polytetramethylene glycol having a molecular weight of about 2000 (100 grams), and dimethylacetamide (DMAc) solvent (362 grams) were placed in a reaction vessel. Variquat 2MS (45.3 grams) was added to a stirred reaction vessel and the reaction mixture was heated to 75° C. and maintained in that temperature range for 4-6 hours. At that time, the reaction product viscosity was found to be 4100 poise at 40C. The reaction was terminated with an excess of butanol mixed with Irganox 245 antioxidant (1 gram) and cooled to ambient conditions.

### Example 2

Spandex containing quaternary amine additives was prepared as follows. A solution of segmented polyether-based polyurethane urea elastomer was prepared by thoroughly mixing diphenylmethane diisocyanate (“MDI”) polytetramethylene glycol having a molecular weight of about 1800 in a molar (“capping”) ratio of 1.63. The mixture was maintained at a temperature of about 80-90° C. for about 90-100 minutes. The resulting “capped glycol”, comprising a mixture of isocyanate-terminated polyether glycol and unreacted diisocyanate, was cooled to 50° C. and mixed with DMAc to provide a solution containing about 45% solids. Then, with vigorous mixing, the capped glycol was reacted for 2-3 minutes at a temperature of about 75° C. with a DMAc solution containing a mixture of diethylamine chain-terminator and 90/10 blend of ethylene diarnine/2-methyl-1,5-diaminopentane chain-extender. The resulting polymer solution contained approximately 35% solids and had a viscosity of about 3,200 poises at 40° C. For spinning, the following ingredients were thoroughly mixed and added to the polymer solution to provide the listed amounts of additive (expressed as weight percent based on the final weight of spandex):

(a) 1.2% of Irganox 245, a hindered phenolic antioxidant,

(b) 0.2% magnesium stearate,

(c) 0.6% of a silicone oil,

(d) 0.17% titanium dioxide as delusterant.

(e) and where applicable, the amount of cationic polyurethane from Example 1 (wt % based on weight of spandex) as listed in the Table.

The spinning solutions were then conventionally dry-spun to form coalesced 18-filament, 235 decitex yarn. A silicone oil finish lubricant was applied to the threadlines by a kiss roll applicator at 4% addition based on the weight of filaments.

### Example 3

Spandex, with and without the inventive additive was knit as 100% fabric and dyed at20/80 weight ratio with 100% polyamide fabric in the same bath under three shades −4% Black, 2% Black, and Skin Tone. After dyeing, the fabric samples were dried and analyzed by colorimeter for dye uptake under the competitive dye situation. Dyeability performance was determined from color shade lightness “L” values with a colorimeter spectral analyzer. Results are reported in CIELAB units. Primary illuminant was D65. Color shade lightness “L” values on the dyed 100% spandex tube fabrics were compared to those for dyed 100% spandex tube fabric comprising the commercial spandex and 100% polyamide from the same dyebath.

The effect of quaternary amine additives on spandex on acid-dye reactivity in a competitive dye bath with polyamide is shown in Table 1. Table 2 also shows consistently higher colorfastness for fabrics of the spandex of Example 2.

TABLE 1
Lab color values for spandex and polyamide fabric samples

| | | | Dye Bath | | | | | | | | |
|---|---|---|---|---|---|---|---|---|---|---|---|
| | Additive | | Black 2% | | | Black 4% | | | Skin Tone/Trichroma | | |
| Item | Level | Fiber | L | a | b | L | A | b | L | a | b |
| Control | 0% | Spandex | 33.0 | 0.16 | −1.44 | 27.6 | 1.05 | −0.7 | 77.5 | 1.84 | 14.5 |
| | | Polyamide | 17.3 | −0.33 | −3.34 | 13.7 | 0.31 | −2.25 | 62.8 | 8.85 | 14.6 |
| Example | 1.50% | Spandex | 20.4 | −0.32 | −3.7 | 16.7 | 0.5 | −0.55 | 59.4 | 7.75 | 24.7 |
| 2 | | Polyamide | 18 | −0.43 | −3.48 | 13.8 | 0.37 | −2.38 | 63.4 | 8.65 | 13.8 |
| Dorlastan | Competi. | Spandex | 18.2 | 0.89 | −0.86 | 17.3 | 1.13 | −0.35 | 60.5 | 10.5 | 22.9 |
| D820 | Control | Polyamide | 17.9 | 0.39 | −3.57 | 13.9 | 0.29 | −2.28 | 62.5 | 8.76 | 14.3 |

TABLE 2
Wash fastness rating for 100% spandex fabrics

| | | |
|---|---|---|
| Control | Example 1 | Dorlastan D820 |

COLOUR FASTNESS TO WATER - UNI EN ISO 105-E01:2013

| | | | |
|---|---|---|---|
| CHANGE | 5 | 5 | 5 |
| IN COLOR | | | |
| STAINING | 5 | 5 | 4,5 |
| WOOL | | | |
| STAINING | 5 | 5 | 4,5 |
| ACRYLIC | | | |
| STAINING | 5 | 5 | 4,5 |
| POLYESTER | | | |
| STAINING | 4,5 | 4,5 | 4 |
| NYLON | | | |
| STAINING | 5 | 5 | 4,5 |
| COTTON | | | |

COLOUR FASTNESS TO DOMESTIC AND COMMERCIAL
LAUNDERING - TCWM 301:2005 at 50° C.

| | | | |
|---|---|---|---|
| CHANGE | 5 | 5 | 4,5 |
| IN COLOR | | | |
| STAINING | 5 | 5 | 4,5 |
| WOOL | | | |
| STAINING | 5 | 5 | 4 |
| ACRYLIC | | | |
| STAINING | 5 | 5 | 4,5 |
| POLYESTER | | | |
| STAINING | 4,5 | 4,5 | 2 |
| NYLON | | | |
| STAINING | 5 | 5 | 4,5 |
| COTTON | | | |

Scale is 1 to 5.

1. A composition comprising spandex and a cationic polyurethane including an N,N-dialkyl-N,N-dialkanolammonium alkylsulfonate.

2. The composition of claim 1 wherein the cationic polyurethane is a quaternized alkylsulfonate polyurethane polymer.

3. A filament or fiber comprising the composition of claim 1.

4. An article of manufacture, at least a portion of which comprises a composition of claim 1.

5. A method of improving dyeability and wash fastness of spandex, said method comprising adding a cationic polyurethane containing N,N-dialkyl-N,N-dialkanolammonium alkylsulfonate to the segmented polyurethane.

6. The method of claim 5 wherein the cationic polyurethane is added by a polyurethane addition route.

7. The method of claim 5 wherein the cationic polyurethane is a quaternized alkylsulfonate polyurethane polymer.
